(19) United States
(12) Patent Application Publication
(10) Pub. No.: US 2005/0275375 A1
(43) Pub. Date: Dec. 15, 2005

(54) Battery charger using a depletion mode transistor to serve as a current source

(76) Inventors: Jing-Meng Liu, Hsinchu (TW); Chung-Lung Pai, Taipei (TW); Hung-Der Su, Luju Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/150,191

(22) Filed: Jun. 13, 2005

(30) Foreign Application Priority Data
Jun. 14, 2004 (TW) 093117085

(51) Int. Cl. H02J 7/00

(52) U.S. Cl. 320/128

(57) ABSTRACT

In a battery charger using a depletion mode transistor to serve as a current source, the depletion mode transistor is self-biased for generating a charging current to charge a battery, thereby requesting no additional control circuit to control the depletion mode transistor, reducing the circuit size, and lowering the cost.

### FIELD OF THE INVENTION

The present invention is related generally to a battery charger and more particularly, to a battery charger using a depletion mode transistor to serve as a current source.

### BACKGROUND OF THE INVENTION

Recently, rechargeable batteries are widely used in various portable products, for example notebook computer, Personal Digital Assistant (PDA), and mobile phone, and therefore battery chargers become more concerned. Typically, a battery charger provides a stable charging current by a current source to charge a battery. For example, in a current-to-voltage transition control of a battery charger provided by U.S. Pat. No. 6,100,667 to Mercer et al., a control circuit is used to monitor the battery voltage and the charging current for the control of the power output. However, this art provides constant charging current, and therefore the battery will be over-charged at the end of the charging phase. To avoid the over-charging to a battery, chargers providing controllable charging current are proposed, for example in U.S. Pat. No. 6,433,510 to Ribellino et al., a control circuit for the charging current of batteries at the end of the charging phase controls the magnitude of the charging current by controlling the resistance of a transistor, such that the charging current decays gradually once the battery voltage reaches a predetermined threshold.

However, these arts need control circuits to control the current sources in the chargers, thereby enlarging the whole circuit and increasing the cost. Therefore, it is desired a lower cost charger.

### SUMMARY OF THE INVENTION

One object of the present invention is to provide a battery charger using a depletion mode transistor to serve as a current source.

Another object of the present invention is to provide a battery charger requesting no additional control circuit to control the current source thereof.

In a battery charger for supplying a charging current, a voltage detector detects the battery voltage to thereby determine a control signal to control a switch, and the switch is coupled to a depletion mode transistor serving as a current source. When the switch turns on, the depletion mode transistor is self-biased to generate the charging current. For the charging current is generated by the self-biased depletion mode transistor, additional control circuit is not necessary, thereby reducing the cost.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a first embodiment of a battery charger according to the present invention;

FIG. 2 shows a second embodiment of a battery charger according to the present invention;

FIG. 3 shows a third embodiment of a battery charger according to the present invention;

FIG. 4 shows a fourth embodiment of a battery charger according to the present invention;

FIG. 5 shows a fifth embodiment of a battery charger according to the present invention;

FIG. 6 shows a sixth embodiment of a battery charger according to the present invention;

FIG. 7 shows a seventh embodiment of a battery charger according to the present invention; and

FIG. 8 shows an eighth embodiment of a battery charger according to the present invention.

### DETAILED DESCRIPTION OF THE INVENTION

FIG. 1 shows a battery charger 100 according to the present invention, in which an enhancement mode NMOS transistor 102 serving as a switch is connected between an input voltage VIN and a depletion mode NMOS transistor 104 serving as a current source. When the enhancement mode NMOS transistor 102 is conductive, the depletion mode NMOS transistor 104 is self-biased to generate a charging current IOUT to charge the battery (Not shown) connected to a charge node VOUT. The battery voltage VOUT is divided by a voltage divider that includes two resistors R1 and R2 connected between the charge node VOUT and ground GND to generate a feedback signal VFB for an operational amplifier 106 serving as a voltage detector to compare with a reference VREF to thereby determine a control signal to control the enhancement mode NMOS transistor 102. When the battery voltage VOUT approaches a predetermined threshold, the operational amplifier 106 will gradually reduce the channel of the enhancement mode NMOS transistor 102, thereby reducing the charging current IOUT gradually, and the battery connected to the charge node VOUT will not be over-charged. Since the depletion mode NMOS transistor 104 serving as a current source is self-biased to generate the charging current IOUT, it requests no additional control circuit to control thereto. Alternatively, the enhancement mode NMOS transistor 102 serving as a switch may be replaced with an enhancement mode JFET, and the depletion mode NMOS transistor 104 serving as a current source may be also replaced with a depletion mode JFET. The enhancement mode JFET serving as a switch and the depletion mode JFET serving as a current source may be integrated together in a same chip.

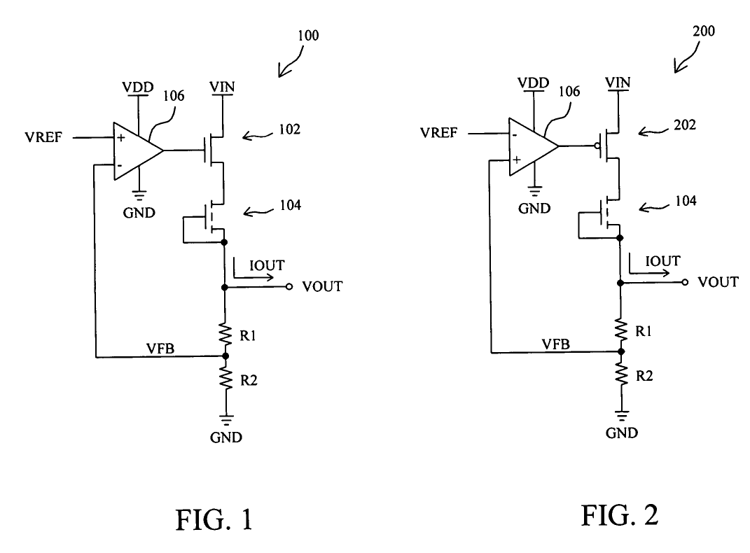

In a battery charger 200 shown in FIG. 2, an enhancement mode PMOS transistor 202 is used instead to serve as the switch connected between the input voltage VIN and depletion mode NMOS transistor 104 serving as a current source, and the other elements are the same as those in the charger 100 of FIG. 1. Similarly, the operational amplifier 106 controls the enhancement mode PMOS transistor 202 by monitoring the battery voltage VOUT. In another embodiment, the enhancement mode PMOS transistor 202 may be replaced with an enhancement mode JFET, and the depletion mode NMOS transistor 104 may be also replaced with a depletion mode JFET. The enhancement mode JFET serving as a switch and the depletion mode JFET serving as a current source may be integrated together in a same chip.

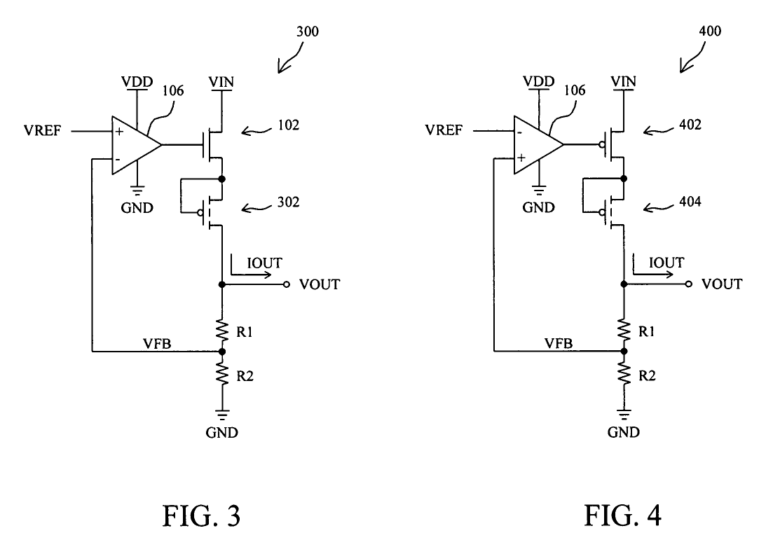

As shown in FIG. 3, the battery charger 100 of FIG. 1 may be modified to be another one 300, in which a depletion mode PMOS transistor 302 is used to serve as the current source connected between the switch 102 and the charge node VOUT. When the enhancement mode NMOS transistor 102 is conductive, the depletion mode PMOS transistor 302 is self-biased to generate a charging current IOUT to charge the battery connected to the charge node VOUT. In other embodiments, the enhancement mode NMOS transistor 102 may be replaced with an enhancement mode JFET, and the depletion mode PMOS transistor 302 may be also replaced with a depletion mode JFET. The enhancement mode JFET serving as a switch and the depletion mode JFET serving as a current source may be integrated together in a same chip.

The battery charger 300 of FIG. 3 is further modified to be another one 400 shown in FIG. 4, which uses an enhancement mode PMOS transistor 402 to serve as a switch connected between an input voltage VIN and a depletion mode PMOS transistor 404 serving as a current source. When the enhancement mode PMOS transistor 402 is conductive, the depletion mode PMOS transistor 404 is self-biased to generate a charging current IOUT to charge the battery connected to the charge node VOUT. In other embodiments, the enhancement mode PMOS transistor 402 may be replaced with an enhancement mode JFET, and the depletion mode PMOS transistor 404 may be also replaced with a depletion mode JFET. The enhancement mode JFET serving as a switch and the depletion mode JFET serving as a current source may be integrated together in a same chip.

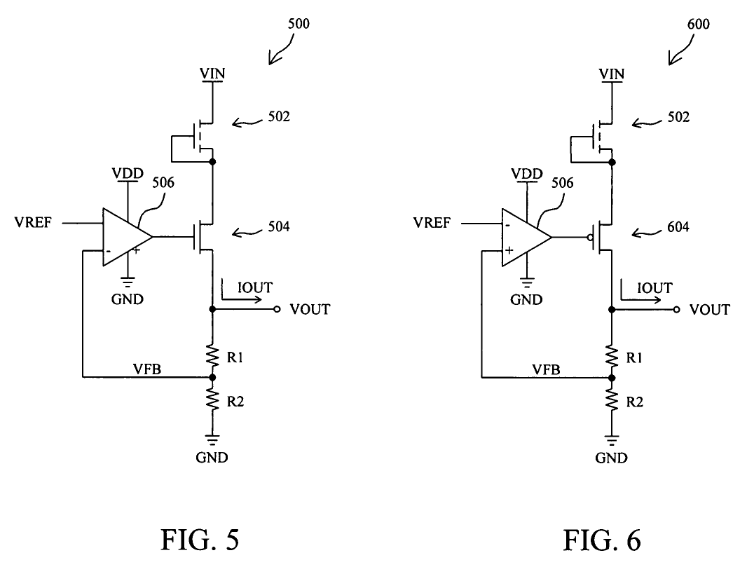

Alternatively, in a battery charger 500 shown in FIG. 5, a depletion mode NMOS transistor 502 serving as a current source is connected between an input voltage VIN and an enhancement mode NMOS transistor 504 serving as a switch, two resistors R1 and R2 are connected between the enhancement mode NMOS transistor 504 and ground GND to generate a feedback signal VFB by dividing the battery voltage VOUT, an operational amplifier 506 serving as a voltage detector to compare the feedback signal VFB with a reference VREF to generate a control signal to control the enhancement mode NMOS transistor 504. When the enhancement mode NMOS transistor 504 is conductive, the depletion mode NMOS transistor 502 is self-biased to generate a charging current IOUT to charge the battery connected to the charge node VOUT. When the battery voltage VOUT approaches a predetermined threshold, the operational amplifier 506 will gradually reduce the channel of the enhancement mode NMOS transistor 504, so as to reduce the charging current IOUT gradually, and the battery will not be over-charged. Since the depletion mode NMOS transistor 502 serving as a current source is self-biased to generate the charging current IOUT, it requests no additional control circuit to control thereto. Again, the depletion mode NMOS transistor 502 and enhancement mode NMOS transistor 504 may be replaced with depletion mode JFET and enhancement mode JFET, respectively, and they may be integrated together in a same chip.

The battery charger 500 of FIG. 5 is modified to be another one 600, as shown in FIG. 6, by replacing the enhancement mode NMOS transistor 504 with an enhancement mode PMOS transistor 604. In other embodiments, the enhancement mode PMOS transistor 604 may be replaced with an enhancement mode JFET, and the depletion mode NMOS transistor 502 may be also replaced with a depletion mode JFET. The enhancement mode JFET serving as a switch and the depletion mode JFET serving as a current source may be integrated together in a same chip.

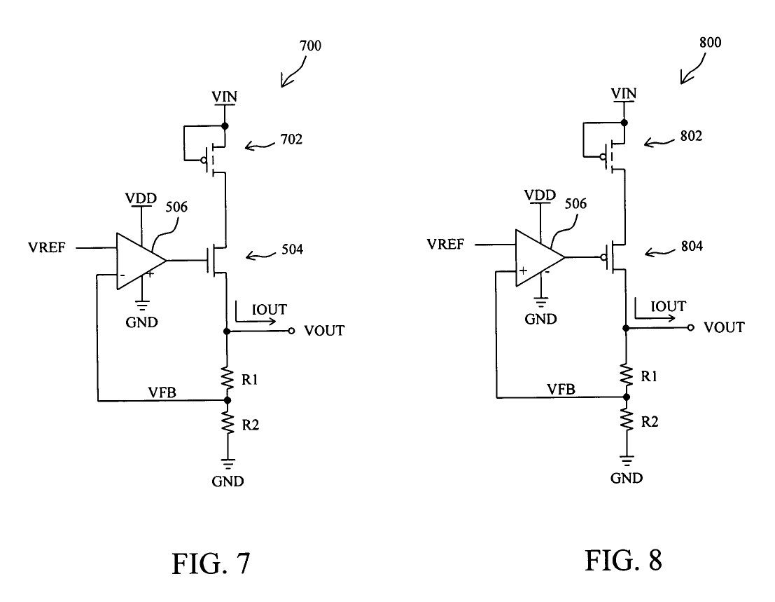

The battery charger 500 of FIG. 5 is further modified to be another one 700, as shown in FIG. 7, by replacing the depletion mode NMOS transistor 502 with a depletion mode PMOS transistor 702 to serve as a current source. When the enhancement mode NMOS transistor 504 is conductive, the depletion mode PMOS transistor 702 is self-biased to generate a charging current IOUT to charge the battery connected to the charge node VOUT. In other embodiments, the enhancement mode NMOS transistor 504 may be replaced with an enhancement mode JFET, and the depletion mode PMOS transistor 702 may be also replaced with a depletion mode JFET. The enhancement mode JFET serving as a switch and the depletion mode JFET serving as a current source may be integrated together in a same chip.

In a modification 800 shown in FIG. 8, a depletion mode PMOS transistor 802 serving as a current source and an enhancement mode PMOS transistor 804 serving as a switch are connected in series between an input voltage VIN and a charge node VOUT. When the enhancement mode PMOS transistor 804 is conductive, the depletion mode PMOS transistor 802 is self-biased to generate a charging current IOUT to charge the battery connected to the charge node VOUT. In other embodiments, the depletion mode PMOS transistor 802 may be replaced with a depletion mode JFET, and the enhancement mode PMOS transistor 804 may be also replaced with an enhancement mode JFET. The enhancement mode JFET serving as a switch and the depletion mode JFET serving as a current source may be integrated together in a same chip.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. A battery charger for supplying a charging current to charge a battery, the battery charger comprising:
a voltage detector for detecting a battery voltage to thereby determine a control signal;
a switch controlled by the control signal; and
a current source including a depletion mode transistor connected to the switch for being self-biased for generating the charging current.

2. The battery charger of claim 1, wherein the depletion mode transistor is a MOSFET.

3. The battery charger of claim 1, wherein the switch is an enhancement mode MOSFET.

4. The battery charger of claim 1, wherein the depletion mode transistor is a JFET.

5. The battery charger of claim 1, wherein the switch is an enhancement mode JFET.

6. The battery charger of claim 1, wherein the depletion mode transistor is a JFET, and the switch is an enhancement mode JFET.

7. The battery charger of claim 7, wherein the depletion mode transistor and switch are integrated in a chip.
